(19) United States
(12) Patent Application Publication
(10) Pub. No.: US 2011/0043875 A1
(43) Pub. Date: Feb. 24, 2011

(54) IMAGE PROCESSING APPARATUS AND IMAGE PROCESSING METHOD

(75) Inventor: Satoshi Tokuda, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/861,246

(22) Filed: Aug. 23, 2010

Related U.S. Application Data
(60) Provisional application No. 61/236,215, filed on Aug. 24, 2009.
(60) Provisional application No. 61/236,217, filed on Aug. 24, 2009.
(60) Provisional application No. 61/236,218, filed on Aug. 24, 2009.

(51) Int. Cl. H04N 1/46

(52) U.S. Cl. 358/501

(57) ABSTRACT

According to one embodiment, an image processing apparatus which reads an original document and generates a monochrome image, includes a scanner configured to output a color signal from a color sensor which reads the original document and a monochrome signal from a monochrome sensor which reads the original document, a signal conversion unit configured to convert the color signal into a monochrome signal based on a conversion characteristic in which an increase rate of a density of the monochrome signal after conversion is lower than an increase rate of a density of the color signal before conversion, a signal processing unit configured to process the monochrome signal converted by the signal conversion unit or the monochrome signal output from the scanner to generate an image, and an image generation unit configured to generate the monochrome image from the processed monochrome signal.

### CROSS REFERENCE TO RELATED APPLICATION

This application is based upon and claims the benefit of U.S. provisional Application No. 61/236,215, filed on Aug. 24, 2009, No. 61/236,217, filed on Aug. 24, 2009, No. 61/236,218, filed on Aug. 24, 2009; the entire contents of which are incorporated herein by reference.

### FIELD

Embodiments described herein relate generally to an image processing apparatus and an image processing method.

### BACKGROUND

In recent years, color documents are increasingly scanned and read by an image forming apparatus such as a digital multi function peripheral (MFP), as color-printed products are increased.

Since a color digital MFP is mounted with a scanner reading the respective densities of R (red), G (green), and B (blue), the color digital MFP can appropriately read a color document. However, since a monochrome digital MFP is mounted with a monochrome scanner determining the density based on a reflection ratio and forming an image, the monochrome digital MFP may not optimally scan a color document.

For example, when a color document is read by the monochrome scanner, light reflected from the original document is incident on the monochrome scanner. Therefore, a variation in the brightness can be read, but information regarding colors may not be read. Then, when information is expressed by red characters on an original document with a blue ground and the reflection ratios of the two colors are the same as each other, blue and red colors may not be distinguished from each other and thus are processed as the same signals. Therefore, when a color document is read by the monochrome scanner, the missing of information may occur. Moreover, when copying is performed on a sheet using the signals, characters, images, or the like may be missed.

In the monochrome digital MFP, when a high-density image of a color document is read by the monochrome scanner to convert the high-density image into a monochrome image, the image may change to solid black. Therefore, when characters or the like are written on the front surface of a high-density image, the characters may not be read due to solid black of a background.

Moreover, in the monochrome MFP, there is a demand for reading a color original document with a seemingly close shade.

### BRIEF DESCRIPTION OF THE DRAWINGS

FIG. 1 is an exemplary view showing the detailed configuration of an image reading unit of an image forming apparatus according to an embodiment.

FIG. 2 is an exemplary view showing the detailed configuration of an image print unit of the image forming apparatus according to an embodiment.

FIG. 3 is an exemplary view showing the overall configuration of a 4-line CCD sensor according to an embodiment.

FIG. 4 is an exemplary view for explaining signal output of a line sensor in more detail according to an embodiment.

FIG. 5A is an exemplary view for further explaining the signal output of a line sensor K according to an embodiment.

FIG. 5B is an exemplary view for further explaining the signal output of the line sensor K according to an embodiment.

FIG. 6 is an exemplary view showing the configuration of a control system of the image forming apparatus according to an embodiment.

FIG. 7 is an exemplary view showing a mode selection screen displayed on a control panel according to an embodiment.

FIG. 8 is an exemplary flowchart showing an overall process procedure of the image forming apparatus in a color document mode according to an embodiment.

FIG. 9 is an exemplary view for explaining the processing details of each unit in the color document mode according to an embodiment.

FIG. 10 is an exemplary flowchart showing overall controlling when a document mode and a zoom ratio are selected from the control panel according to an embodiment.

FIG. 11 is an exemplary view showing a display example of the control panel when the document mode and a zoom ratio are selected on the control panel according to an embodiment.

FIG. 12 is an exemplary flowchart showing copying based on Variation 1 according to an embodiment.

FIG. 13 is an exemplary flowchart showing copying based on Variation 2 according to an embodiment.

### DETAILED DESCRIPTION

In general, according to one embodiment, an image processing apparatus which reads an original document and generates a monochrome image, comprising: a scanner configured to output a color signal from a color sensor which reads the original document and a monochrome signal from a monochrome sensor which reads the original document; a signal conversion unit configured to convert the color signal into a monochrome signal based on a conversion characteristic in which an increase rate of a density of the monochrome signal after conversion is lower than an increase rate of a density of the color signal before conversion; a signal processing unit configured to process the monochrome signal converted by the signal conversion unit or the monochrome signal output from the scanner to generate an image; and an image generation unit configured to generate the monochrome image from the processed monochrome signal.

Hereinafter, an exemplary image forming apparatus (MFP: Multi Function Peripheral) 100 according to an embodiment of the invention will be described.

The MFP 100 is a digital multi function peripheral which scans, reads, and copies an image with a designated resolution and a sheet size, and also utilizes office apparatus functions, such as a function of receiving an image by a FAX, a function of receiving an image by an E-mail, and a function of receiving a print image via a network, in an integrated manner.

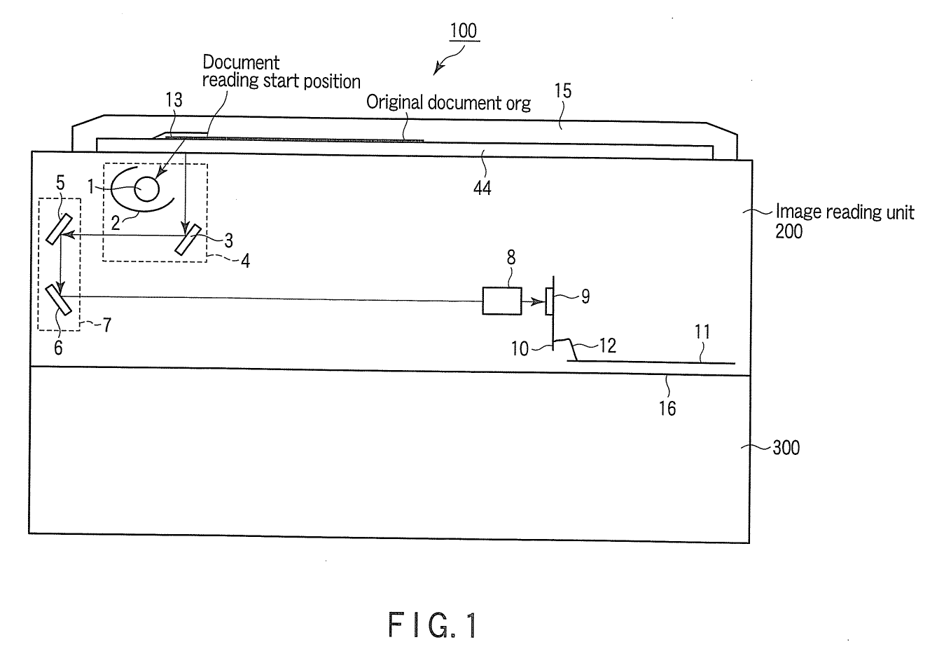

FIG. 1 is an exemplary view showing the detailed configuration of an image reading unit of the image forming apparatus according to an embodiment. In the image reading unit 200, an original document org is placed on a document platen glass 44 so that the document surface faces downward. When a document fixing cover 15 provided to be opened and closed is closed, the original document org is pressed down against the document platen glass 44. The original document org is illuminated with light by a light source 1, and then the light reflected from the original document org is imaged on the sensor surface of a CCD line sensor 9 mounted on a CCD sensor substrate 10 via a first mirror 3, a second mirror 5, a third mirror 6, and a condensing lens 8.

With the original document org, while a first carriage 4 including the light source 1 and the first mirror 3 and a second carriage 7 including the second mirror 5 and the third mirror 6 are moved by a carriage driving motor (not shown), an illuminated light from the light source 1 scans the original document org. As for the movement of the first and second carriages, since the movement speed of the first carriage 4 is set to the double of the movement speed of the second carriage 7, the length of a light path from the original document org to the CCD line sensor 9 is controlled to be constant.

The original document org placed on the document platen glass 44 is sequentially read one line by one line, and the CCD line sensor 9 converts the read signals into analog electric signals in accordance with the strength of light signal which is the reflected light. Thereafter, the converted analog electric signals are converted into digital signals, and then the converted digital signals are delivered to a control substrate 11 processing a control signal associated with a CCD sensor via a harness 12. The control substrate 11 performs digital signal processing such as shading (distortion) correction of correcting low-frequency distortion caused by the condensing lens 8 or high-frequency distortion caused due to a sensitivity variation of the CCD line sensor 9.

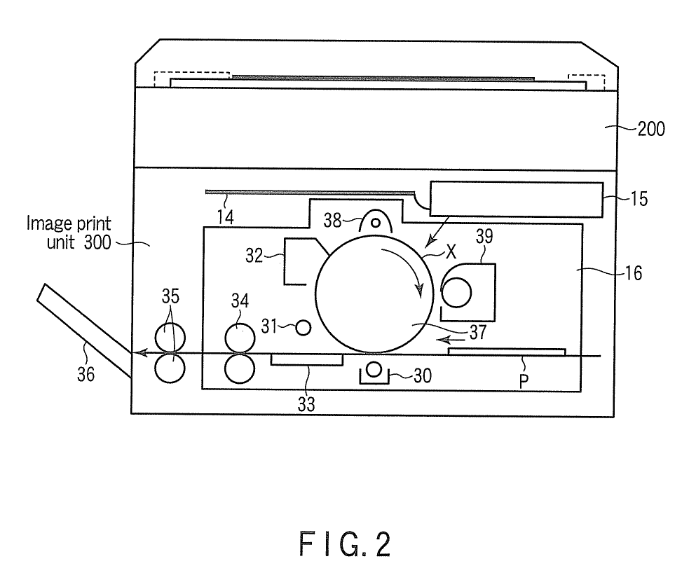

FIG. 2 is an exemplary view showing the detailed configuration of an image print unit of the image forming apparatus according to an embodiment. An image print unit 300 shown in FIG. 2 generates a monochrome image from the original document read by the image reading unit 200.

The image print unit 300 includes an image processing unit 14, a laser optical system unit 15, and an image forming unit 16. The image processing unit 14 performs a process necessary for generating an image. For example, the image processing unit 14 performs a filter process, a gray-scale process, or the like on image data read by the CCD line sensor 9 of the image reading unit 200 and converts a signal into a control signal of a light-emitting element such as a semiconductor laser (not shown). A light-emitting element, such as a semiconductor laser, forming a latent image on a photoconductive drum 37 is disposed in the laser optical system unit 15.

The image forming unit 16 includes the photoconductive drum 37, a charging unit 38, a development unit 39, a transfer charger 30, a detachment charger 31, a cleaner 32, a sheet transporting mechanism 33, and a fixing unit 34. The photoconductive drum 37 maintains an image to be generated by an electrophotographic process. The sheet transporting mechanism 33 transports a sheet P. The sheet P on which an image is formed by the image forming unit 16 is discharged to a discharge tray 36 through paper discharge rollers 35.

The image forming apparatus 100 according to this embodiment includes a color scanner (4-line CCD) as the CCD line sensor 9. The image forming unit 16 includes a monochrome print mechanism.

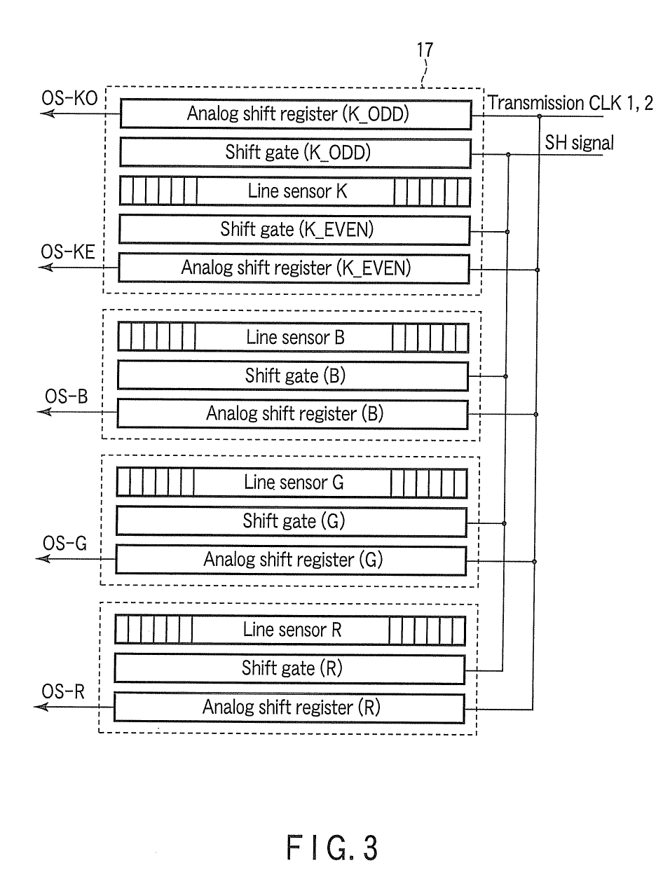

FIG. 3 is an exemplary view showing the overall configuration of the 4-line CCD sensor according to an embodiment.

Since the configuration of a line sensor K is partially different from the configurations of line sensors R, G, and B, the configuration of the line sensors R, G, and B will be first described.

When the light sensors R, G, and B are illuminated with light, light-receiving elements of the respective line sensors generate charges in accordance with the amount of illuminated light and an illumination time in every pixel. When an SH signal is input to each shift gate, the charges corresponding to respective pixels are supplied to each analog shift register via a shift gate. The analog shift register outputs the charges (image information) corresponding to the pixels to a serial from each line sensor in synchronization with transmission clocks CLK1 and CLK2.

Here, the transmission clocks CLK1 and CLK2 form differential signals of mutually inverse phases to move the charges at high speed.

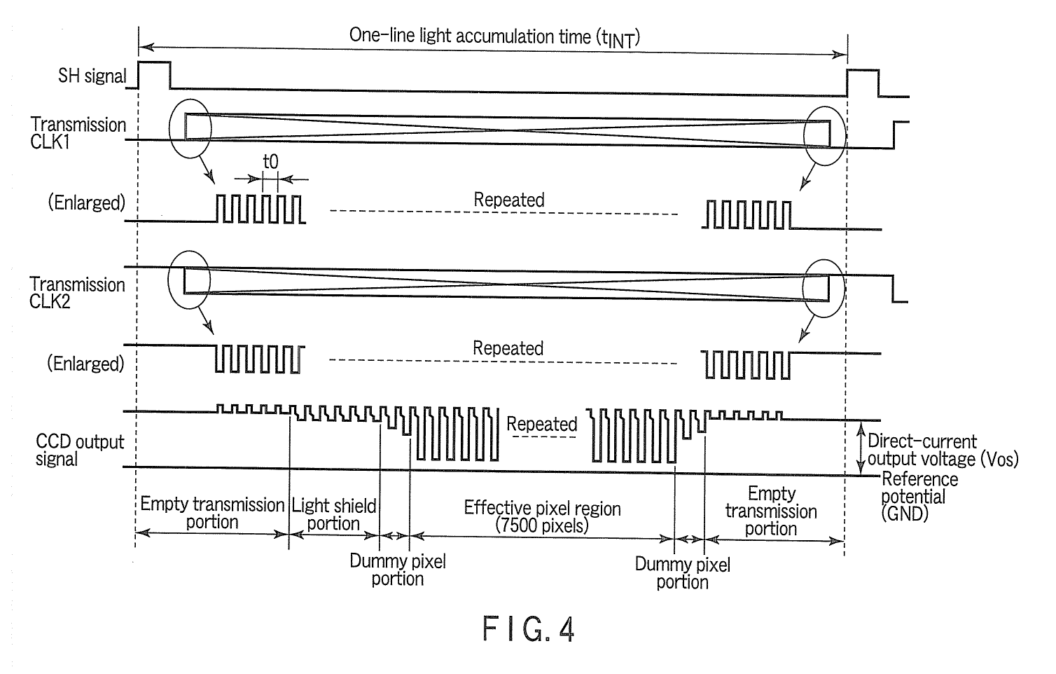

FIG. 4 is an exemplary view for explaining the signal output of the line sensor in more detail according to an embodiment.

The line sensor includes a light shield pixel portion, in which the light-receiving element is covered with aluminum or the like so that light is not incident on the front stage of 7500 effective pixels, a dummy pixel portion, and an empty transmission portion.

Therefore, in order to transmit all the signal outputs of the line sensor to the outside, the number of transmission clocks corresponding to pixels more than 7500 pixels is necessary. Here, if the sum of the light shield portion, the empty transmission portion, and the dummy pixel portion is set to correspond to 500 pixels, the transmission clocks corresponding to 8000 pixels are necessary and this point of time serves as a big factor for determining a one-line light accumulation time (tINT).

That is, the light-receiving element in the line sensor repeats generating charges in accordance with the light reflected from the original document during the one-line light accumulation time (tINT), transmitting the charges to the analog shift register when the SH signal is input, and outputting the signal to the outside in synchronization with the transmission clock during the next light accumulation time (tINT).

Next, the line sensor K will be described. The basic process of the line sensor K is the same as that of the line sensors R, G, and B, but two pairs of shift gate and analog shift registers are provided, as known from FIG. 3.

When the line sensor K is illuminated with light, the light-receiving elements of the line sensor K generate charges in accordance with the amount of illuminated light and an illumination time in every pixel. When an SH signal is input to a shift gate K_ODD and a shift gate K_EVEN, the charges corresponding to odd pixels are supplied to an analog shift register K_ODD via a shift gate and the charges corresponding to even pixels are supplied to an analog shift register K_EVEN via a shift gate. The analog shift registers each output the charges (image information) corresponding to the odd and even pixels to a serial in synchronization with transmission clocks CLK 1 and 2.

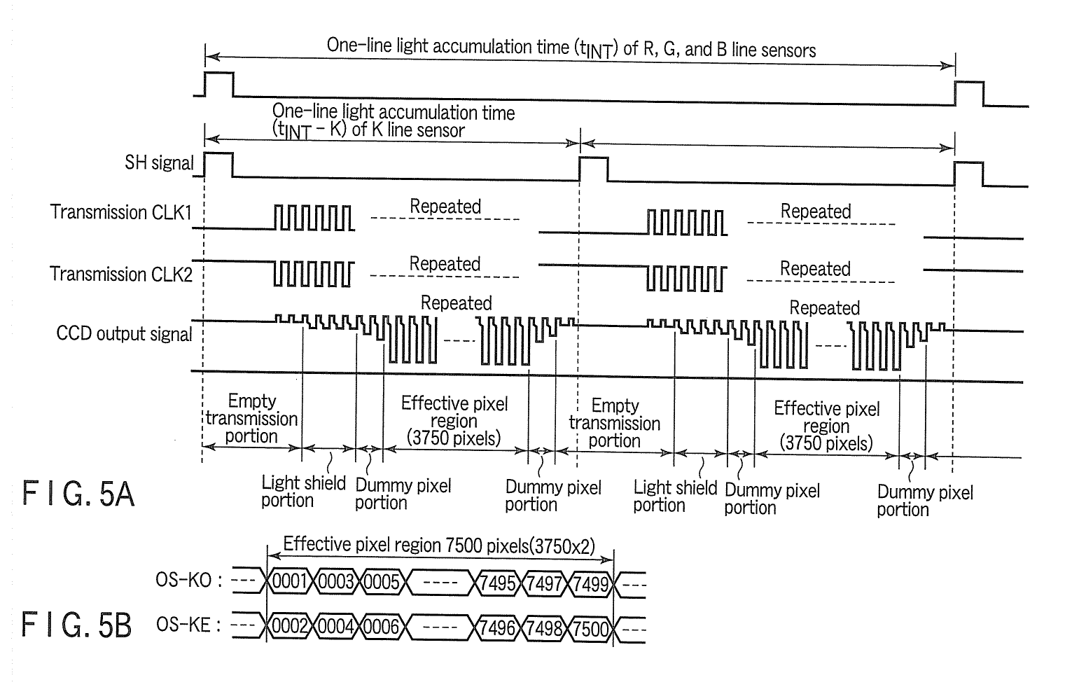

FIGS. 5A and 5B are exemplary views for further explaining the signal output of the line sensor K according to an embodiment.

Like the line sensors R, G, and B, the line sensor K includes a light shield pixel portion, in which the light-receiving element is covered with aluminum or the like so that light is not incident on the front stage of 7500 effective pixels, a dummy pixel portion, and an empty transmission portion. In addition, the sum of the light shield portion, the empty transmission portion, and the dummy pixel portion correspond to 500 pixels.

In the line sensor K, as described above, the charges are separated into two charges for transmission by the odd pixels and the even pixels. Therefore, the transmission clocks necessary for outputting the charges (pixel information) corresponding to 8000 to a serial correspond to 4000 pixels. Therefore, the period of the SH signal input to the shift gate can be shortened and the one-line light accumulation time (tINT) can be shortened. As described above, the line sensor K is a high-sensitivity sensor. Therefore, even when the one-line light accumulation time (tINT) is shortened, no problem occurs.

In FIG. 5A, the period (tINT-K) of the SH signal in the line sensor K is set to the half of the period (tINT) of the SH signal of the above-described line sensors R, G, and B. In FIG. 5B, the effective pixel region corresponds to 3750 pixels, and the signals respectively corresponding to the odd pixels and the even pixels are output separately from the analog shift registers.

As described above, the line sensor K in the 4-line CCD sensor 9 can realize the reading speed which is the double of the reading speed of the line sensors R, G, and B.

When the sensitivity of the line sensor K is spare, the higher speed can be realized. For example, when the outputs of the line sensor K are separated into odd and even and are further separated into the first-half output and the second-half output, a quadruple reading speed can be realized.

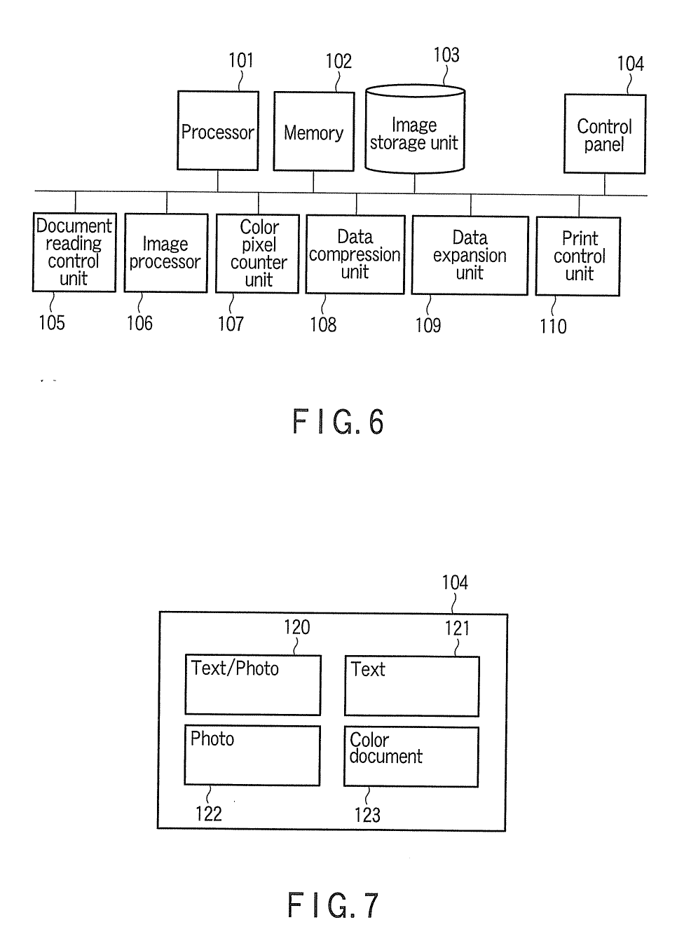

FIG. 6 is an exemplary view showing the configuration of a control system of the image forming apparatus according to an embodiment.

The control system of the image forming apparatus 100 includes a processor 101, a memory 102, an image storage unit 103, a control panel 104, a document reading control unit 105, an image processor 106, a color pixel counter unit 107, a data compression unit 108, a data expansion unit 109, and a print control unit 110.

The processor 101 generally controls the process of each unit of the image forming apparatus 100. The memory 102 stores data used for the process of each unit, processed result data, and the like. The image storage unit 103 stores image data. The control panel 104 inputs an instruction given to the image forming apparatus 100, and displays information output by the image forming apparatus 100.

The document reading control unit 105 controls a process associated with the image reading. The document reading control unit 105 outputs a color signal and a monochrome signal read from a document image by the 4-line CCD sensor. The image processor 106 executes processes such as a process of converting the read color signal into a monochrome signal and a process of adjusting the image quality during the printing. The color pixel counter unit 107 counts the number of color pixels of the respective read RGB. The data compression unit 108 compresses the image data and stores the compressed image data in the image storage unit 103. The data expansion unit 109 obtains the image data from the image storage unit 103 to expand the image data. The print control unit 110 controls a process associated with the printing of an image.

FIG. 7 is an exemplary view showing a mode selection screen displayed on the control panel according to an embodiment.

The image forming apparatus 100 according to this embodiment provides four modes, that is, a “TEXT mode”, a “Photo mode”, a “TEXT/Photo mode”, and a “color document mode”, as document modes corresponding to the kinds of read document. The “TEXT mode” is a mode for reading a text document. The “Photo mode” is a mode for reading a photo document. The “TEXT/Photo mode” is a mode for reading an original document in which a text and a photo coexist. The “color document mode” is a mode for reading a color document. UI (User Interface) buttons 121 to 123 used to select these modes are displayed on the control panel 104.

When a user presses down the color document mode button 123 on the control panel 104, the image forming apparatus 100 allows a color CCD to read image data. In the “TEXT mode”, the “Photo mode”, and the “TEXT/Photo mode”, the image forming apparatus 100 allows a monochrome CCD to read image data and forms an image.

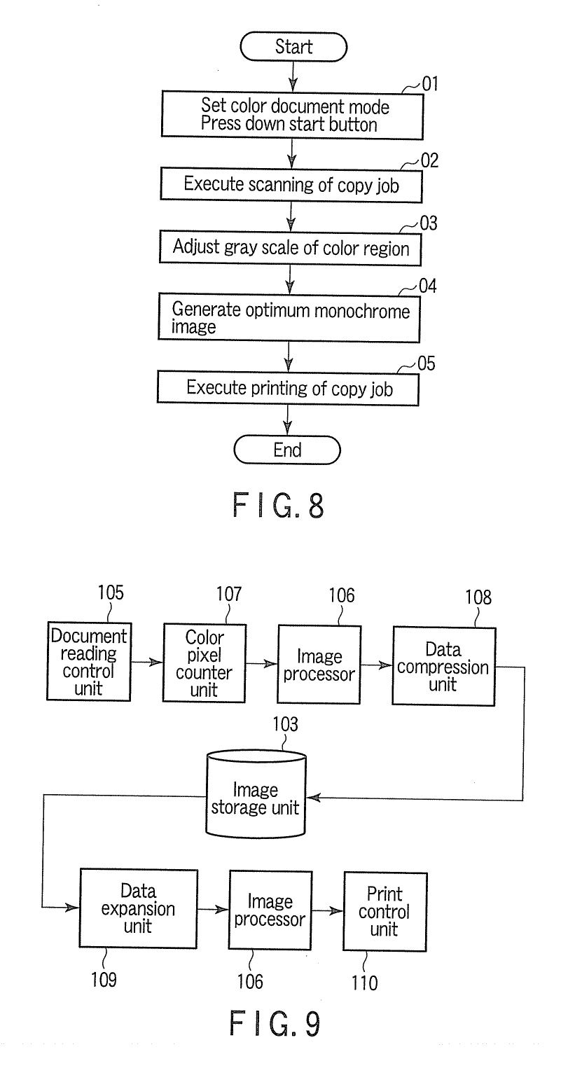

FIG. 8 is an exemplary flowchart showing the overall processing procedure of the image forming apparatus in the color document mode according to an embodiment. FIG. 9 is an exemplary view for explaining the processing details of each unit in the color document mode according to an embodiment. The operation of the color document mode will be described with reference to FIGS. 8 and 9.

When the user selects the color document mode from the control panel 104 and presses down a start button on the control panel 104 in Act 01 of FIG. 8, the document reading control unit 105 executes scanning of a copy job in Act 02. The document reading control unit 105 converts a light image of the scanned document into the image data using the 4-line CCD. The color pixel counter unit 107 counts the number of pixels based on RGB data obtained through the reading of the document reading control unit. In addition, the color pixel counter unit 107 compares the counter value and a preset threshold value to determine whether the read document is a color document or a monochrome document.

In Act 03 and Act 04, the image processor 106 converts the color signal into the monochrome signal using an image processing ASIC. In a conversion table used for the image processing ASIC to execute the conversion, a conversion characteristic is set such that when the density of the color signal before the conversion is high, the density of the monochrome signal after the conversion becomes low in advance. That is, the conversion characteristic is set such that the increase rate of the density of the monochrome signal after the conversion is lower than an increase rate of the density of the color signal before the conversion.

A known monochrome digital MFP using only a brightness signal performs converting of thickening a low-density portion based on a reflection ratio in order to prioritize reproduction of characters. Then, the resolution capability of a high-density portion and a dark portion may become low and solid black may easily occur. Accordingly, based on the conversion table according to this embodiment, optimum monochrome data can be generated. Moreover, in the above-described conversion table, one monochrome signal is determined to correspond to one combination of RGB, but the invention is not limited thereto. The monochrome signal can be generated from the color signal in various ways. The data compression unit 108 compresses the generated monochrome data and stores the compressed monochrome data in the image storage unit 103.

In Act 05, the printing of the copy job is executed. That is, the data expansion unit 109 expands the compressed data extracted from the image storage unit 103. The image processor 106 adjusts the image quality of the expanded RAW data. The print control unit 110 prints the monochrome image on a sheet.

The image processor 106 performs image processing on the monochrome signal output from the monochrome CCD in a mode other than the color document mode.

In the image forming apparatus 100 according to this embodiment, however, there is a limit to a document reading speed in the color document mode. The details thereof will be described.

When the image forming apparatus 100 mounted with a CCD of the 4-line sensor performs scanning using a color CCD, zoom-in is supported in the range from 100% to 200% but a zoom-in ratio exceeding 200% is not supported. On the other hand, when reading is performed using the monochrome CCD, zoom-in can be performed in the range from 100% to 400%.

Here, when n-times zoom-in is performed, the movement speed of the carriage is controlled to 1/n. Therefore, upon the scanning, the movement speed of the carriage has to be controlled to the range from about ½ to about ¼ in order to realize the zoom-in from 201% to 400%. However, there is a difference in the sensitivity between the monochrome sensor and the RGB color sensor, as described above, and the sensitivity of the color sensor is the half of the sensitivity of the monochrome sensor.

Therefore, in order to realize the zoom-in from 201% to 400% using the color CCD, it is necessary to control the movement speed of the carriage corresponding to the reading range from 400% to 800% in the monochrome sensor. However, in order to realize the low-speed process of the carriage, the size of a motor driving the carriage has to be increased, thereby causing the apparatus cost to be increased.

In order to solve this problem, when printing at zoom-in from 201% to 400% is necessary, it can be considered that the zoom-in of the maximum 200% is performed by controlling the movement speed of the carriage, the input image data in the sub-scanning direction is expanded from 101% to 200% by signal processing of the image processing ASIC, and then the zoom-in from 100% to 400% is finally performed. In this method, however, the image processing ASIC has to have a zoom-in function in a sub-scanning direction, thereby causing the apparatus cost to be increased. Even if the zoom-in from 100% to 400% is possible, a user may not buy a high-cost, that is, expensive image forming apparatus.

Accordingly, the image forming apparatus 100 according to this embodiment realizes the following functions.

(1) When a zoom ratio exceeding 200% is selected upon selecting the color document mode, a control function of restricting scanning is implemented in the image forming apparatus 100.

(2) When a zoom ratio exceeding 200% is selected upon selecting the color document mode, a control function of restricting user template registration is implemented in the image forming apparatus 100.

The template refers to a function of registering setting details of a frequently used function by a user and allowing the user to press down a button and give an instruction, as necessary, in order to reflect the registered setting details on a JOB.

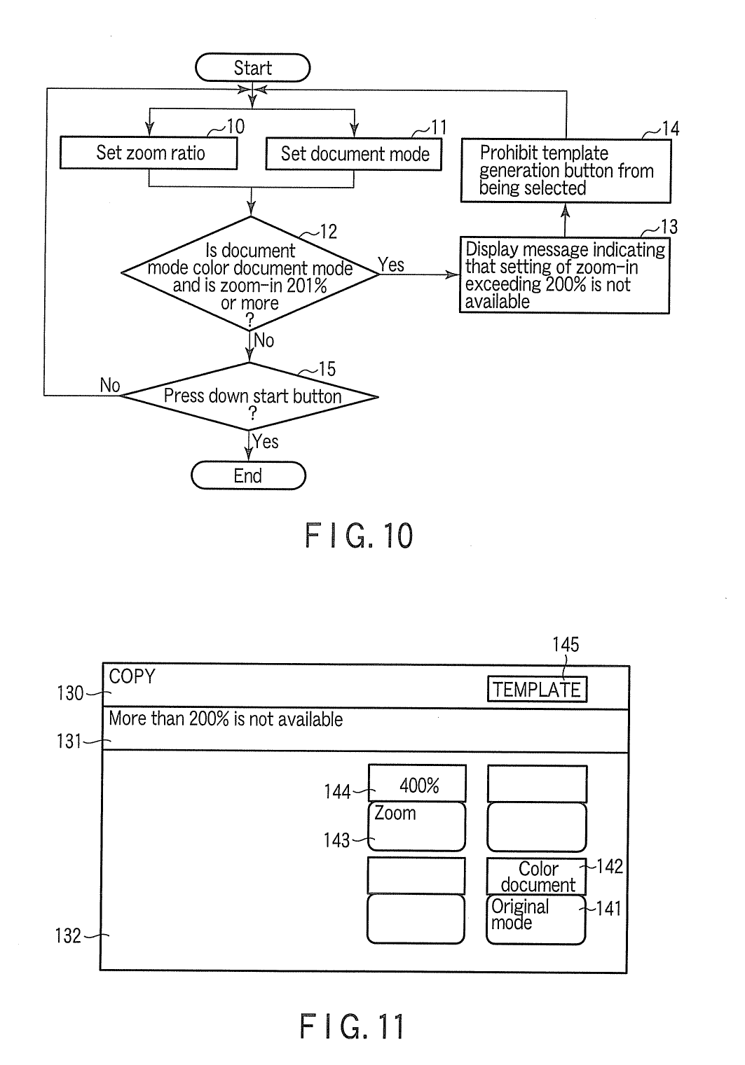

FIG. 10 is an exemplary flowchart showing overall controlling when a document mode and a zoom ratio are selected from the control panel according to an embodiment.

In Act 10, the processor 101 acquires the zoom ratio set on the control panel 104 by the user. The zoom ratio may be designated directly by the user or may be acquired based on combinations of document sizes and sheet sizes. In Act 11, the processor 101 acquires the document mode set on the control panel 104 by the user.

In Act 12, the processor 101 checks whether the document mode is the color document mode and the zoom-in ratio exceeds 200%. If the result is Yes in Act 12, the processor 101 displays a message indicating that expansion printing of the zoom-in exceeding 200% is not available on the control panel 104 in Act 13. The processor 101 controls the start button so as not to start the copy job even when the user presses down the start button during the displaying of the above message.

In Act 14, the processor 101 prohibits a template generation button from being selected so that the template is not registered. The reason for prohibiting the template generation button from being selected is to prevent the inexecutable combinations from being registered in advance in the template when the template is registered. In addition, the processor 101 receives the change setting of the zoom ratio on the control panel 104 in Act 10.

If the result is No in Act 12, that is, the document mode is not the color document mode or the zoom-in is set to be 200% or less, the processor 101 checks whether the start button is pressed down in Act 15. If the result is No in Act 15, that is, the setting is not finished, the processor 101 receives the setting from the Act 10. If the result of Act 15 is Yes, that is, the setting is finished and the start button is pressed down, the copying is executed.

FIG. 11 is an exemplary view showing a display example of the control panel when the document mode and the zoom ratio are selected on the control panel according to an embodiment.

The control panel 104 includes a first region 130, a second region 131, and a third region 132. Whenever the user presses down a document mode button 141 in the third region, the selected document mode is displayed on a display section 142. In FIG. 11, the color document mode is selected. Whenever the user presses down a zoom ratio button 143 in the third region, a selected zoom ratio is displayed in a display section 144. In FIG. 11, 400% is selected.

When the selected zoom ratio exceeds 200% and the document mode is the color document mode, a message indicating the zoom ratio exceeding 200% is not available is displayed in the second region. The copy is not permitted to be started even when a copy start button is pressed down. When the selected zoom ratio exceeds 200% and the document mode is the color document mode, a template generation button 145 in the first region is grayed out. In addition, the template generation button 145 does not respond even when the template generation button 145 is pressed down.

The display of the message and the prohibition of the operation of the template button are cancelled when the selected zoom ratio is 200% or less, or the setting is changed to the document mode other than the color document mode.

By performing the controlling in this manner, the user is not permitted to expand the zoom ratio exceeding 200% when the color document mode is selected.

Next, the image forming apparatus 100 according to variation examples will be described.

### Variation 1: Automation of Color Document Mode

When monochrome copy printing is performed on a color document, the user needs to select the “color document mode” using the button on the control panel in order to obtain a clearer print result. In this method, however, the user has to do work to recognize whether the original document is a color document and select the color document mode as the result.

Accordingly, when the color document mode is automatically executed without the selection by the user, the work of the user can be reduced, thereby obtaining a clear monochrome print. In addition, scanning such as ScanToFile/Box or FAX transmission as well as the copy job is applicable.

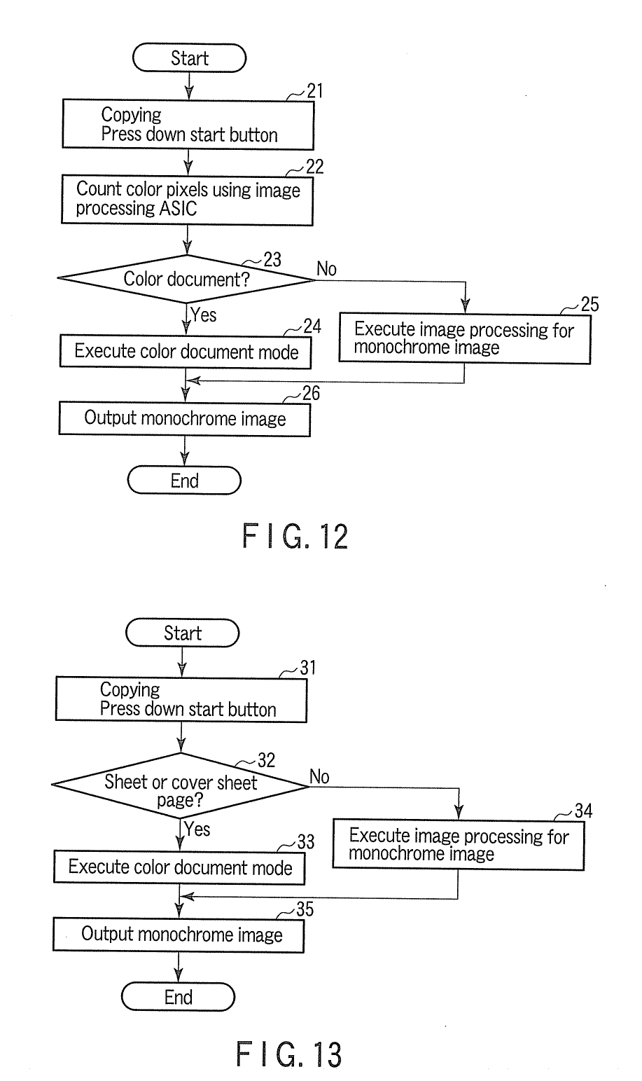

FIG. 12 is an exemplary flowchart showing copying based on Variation 1 according to an embodiment.

In Act 21, when the user presses down a copy button, the document reading control unit 105 executes scanning using the color CCD. In Act 22, the image processing unit 106 automatically determines whether the scanned document is a color document. As a technique for automatically determining whether an original document is a color document, known ACS (Auto Color Selection) can be used. In Act 22, the image processing unit 106 counts color pixels using an image processing ASIC.

If the result is Yes in Act 23, that is, the number of counted color pixels is equal to or larger than a threshold value, the original document is determined as the color document and the process proceeds to Act 24. In Act 24, the image processor 106 executes the color document mode. That is, the color signal is converted into the monochrome signal using a table by which the color image signal is optimally made monochromatic.

If the result is Yes in Act 23, that is, the number of counted color pixels is equal to or larger than a threshold value, the original document is determined as the color document and the process proceeds to Act 24. In Act 24, the image processor 106 executes the color document mode. That is, a portion with a relative high density in a color component is replaced by pixels with a low density based on a color conversion table for the color document mode and is converted into a monochrome image.

If the result is NO in Act 23, that is, the number of counted color pixels is equal to or smaller than a threshold value, the original document is determined as the monochrome document and the process proceeds to Act 25. In Act 25, the image processor 106 executes gray scale conversion for the monochrome image on the monochrome signal output by the monochrome CCD.

In Act 26, necessary image processing is executed on the monochrome image to execute the monochrome printing as in a known example.

According to Variation 1, the color document mode can be automatically executed.

### Variation 2: Application of Color Document Mode for Each Sheet

In some cases, a sheet cover is inserted into the generated document and/or a partition sheet is inserted for printing. In many cases, a color image is used on the cover sheet or the sheet. When the color document mode is applied in a job unit in a case where there are the cover sheet and/or the sheet and another page in the same JOB, a drawback (problem) may arise in that, for example, the color document mode is applied to pages for only characters and print quality deteriorates. In contrast, when the text mode is applied in a job unit in a case where the text mode is desired to be applied, there is a possibility that the text mode is applied to pages, such as the cover sheet or the sheet, for a color document and thus the print quality deteriorates.

According to Variation 2, the color document mode is applicable only to the pages in to which a cover sheet or a sheet is inserted. That is, according to Variation 2, the document modes can be switched in a page unit for one JOB.

FIG. 13 is an exemplary flowchart showing copying based on Variation 2 according to an embodiment.

The user designates a sheet-inserted page on the control panel 104. Then, the user sets one of the “TEXT mode”, the “Photo mode”, and the “Text/Photo mode” on the control panel 104 and turns on an “automatic color document mode” which is a newly provided document mode setting button. If the user presses down the copy button in Act 31, the processor 101 determines whether or not an original document to be read by the document reading control unit 105 is a cover sheet or sheet page based on the page number designated by the user in Act 32.

If the result is Yes in Act 32, that is, the original document is the cover sheet or sheet page, image processing for the color document mode is executed on this page in Act 33. For example, when the insertion of the sheet is set in pages 2, 4, and 6, the color document mode is applied to the color signals obtained from the pages 2, 4, and 6 by the color CCD.

If the result is No in Act 32, that is, the original document is not either the cover sheet or sheet page, the gray scale conversion for the monochrome image is executed on the monochrome signal read by the monochrome CCD based on the document mode (character•character/photo•photo) set in advance in the control panel 104 in Act 34.

In Act 35, necessary image processing is executed on the monochrome image to execute the monochrome printing as in a known example.

If the color document mode is applied in Act 33, it may be automatically determined whether an original document is a color document, as described in FIG. 12, and the color document mode may be applied only to the color document.

When the newly provided “automatic color document mode” is turned off, the flow shown in FIG. 13 may not be executed, and the image processing is executed on all pages of one JOB in the same document mode, as in the known example.

In the image forming apparatus according to the above-described embodiment, the considerable advantages can be obtained compared to a known technique.

(1) When a color document is read by the monochrome sensor and only the reflection ratio is processed, solid black occurs. By reading the color document using the RGB color sensor and processing output signals of the RGB sensor, an image with a higher resolution can be obtained. Therefore, a clearer copied image can be obtained compared to a known monochrome device.

(2) By prohibiting a user from performing the zoom-in at a zoom ratio exceeding 200% when the color document mode is selected, a cheaper MFP can be provided.

(3) By automatically determining whether an original document is a color document and applying the color document mode, the clear monochrome image can be automatically obtained without recognition of a user.

(4) By automatically applying the color document mode only when a cover sheet or a sheet is inserted, a clearer cover sheet or a sheet can be printed without influence on another document.

Each function described in the above-described embodiment may be realized by hardware. Alternatively, each function may be realized by causing a computer to read a program of each function by software. Each function may be configured by appropriately selecting one of software or hardware.

Each function may be realized by causing a computer to read a program stored in a record medium (not shown). The record medium according to this embodiment may record a program and any record form may be used as long as a computer can read the record medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus which reads an original document and generates a monochrome image, comprising:
a scanner configured to output a color signal from a color sensor which reads the original document and a monochrome signal from a monochrome sensor which reads the original document;
a signal conversion unit configured to convert the color signal into a monochrome signal based on a conversion characteristic in which an increase rate of a density of the monochrome signal after conversion is lower than an increase rate of a density of the color signal before conversion;
a signal processing unit configured to process the monochrome signal converted by the signal conversion unit or the monochrome signal output from the scanner to generate an image; and
an image generation unit configured to generate the monochrome image from the processed monochrome signal.

2. The apparatus of claim 1, further comprising:
a first setting unit configured to set a document mode corresponding to a kind of original document to be read;
a second setting unit configured to set a zoom ratio at which the read image is printed;
a determination unit configured to determine whether a condition in which the document mode set by the first setting unit is a color document mode for reading a color document and the zoom ratio set by the second setting unit exceeds a predetermined zoom ratio is satisfied; and
a display unit configured to display a message, which indicates that setting of the zoom ratio exceeding the predetermined zoom ratio is not available, until the condition ceases to be satisfied, when the determination unit determines that the condition is satisfied.

3. The apparatus of claim 2, further comprising:
a copy prohibition unit configured to prohibit the image processing apparatus from performing copying, when the condition is satisfied.

4. The apparatus of claim 2, further comprising:
a template registration prohibition unit configured to prohibit template registration, when the condition is satisfied.

5. The apparatus of claim 1, further comprising:
a first setting unit configured to set a document mode corresponding to a kind of original document to be read,
wherein the signal processing unit processes the monochrome signal converted by the signal conversion unit to generate an image when the first setting unit sets a color document mode to read a color document, and processes the monochrome signal output from the scanner to generate the image when the first setting unit sets a mode other than the color document mode.

6. The apparatus of claim 5, wherein the scanner reads the original document using a 4-line CCD sensor.

7. The apparatus of claim 1, further comprising:
an information input unit configured to input information regarding a page of an original document into which a cover sheet or a sheet is inserted,
wherein the signal conversion unit converts a color signal, which is output from the scanner reading the original document of the page input by the information input unit, into a monochrome signal based on the conversion characteristic in which the increase rate of the density of the monochrome signal after conversion is lower than the increase rate of the density of the color signal before conversion, and
wherein the signal processing unit processes the monochrome signal converted by the signal conversion unit to generate an image.

8. The apparatus of claim 7, wherein the signal processing unit processes a monochrome signal, which is output from the scanner reading an original document of a page other than the page input by the information input unit, to generate an image.

9. The apparatus of claim 1, further comprising:
an information input unit configured to input information regarding a page of an original document into which a cover sheet or a sheet is inserted; and
an ACS unit configured to determine whether an original document is a color document based on a color signal,
wherein when the ACS unit determines that the original document is the color document based on a color signal output from the scanner reading the original document of the page input by the information input unit, the signal conversion unit converts the color signal into a monochrome signal based on the conversion characteristic in which the increase rate of the density of the monochrome signal after conversion is lower than the increase rate of the density of the color signal before conversion, and
wherein the signal processing unit processes the monochrome signal converted by the signal conversion unit to generate an image.

10. An image processing apparatus which reads an original document and generates a monochrome image, comprising:
a scanner configured to output a color signal from a color sensor which reads the original document and a monochrome signal from a monochrome sensor which reads the original document;
an ACS unit configured to determine whether the original document is a color document based on the color signal;
a signal conversion unit configured to convert the color signal into a monochrome signal based on a conversion characteristic in which an increase rate of a density of the monochrome signal after conversion is lower than an increase rate of a density of the color signal before conversion, when the ACS unit determines that the original document is the color document;
a signal processing unit configured to process the converted monochrome signal to generate an image when the ACS unit determines that the original document is the color document, and process the output monochrome signal to generate an image when the ACS unit determines that the original document is not the color document; and
an image generation unit configured to generate the monochrome image from the processed monochrome signal.

11. The apparatus of claim 10, wherein the scanner reads the original document using a 4-line CCD sensor.

12. An image processing method of an image processing apparatus reading an original document and generating a monochrome image, the method comprising:
outputting a color signal from a color sensor which reads the original document and a monochrome signal from a monochrome sensor which reads the original document;
converting the color signal into a monochrome signal based on a conversion characteristic in which an increase rate of a density of the monochrome signal after conversion is lower than an increase rate of a density of the color signal before conversion;
processing the converted monochrome signal or the output monochrome signal to generate an image; and
generating the monochrome image from the processed monochrome signal.

13. The method of claim 12, further comprising:
setting a document mode corresponding to a kind of original document to be read;
setting a zoom ratio at which the read image is printed;
determining whether a condition in which the set document mode is a color document mode for reading a color document and the set zoom ratio exceeds a predetermined zoom ratio is satisfied; and
displaying a message, which indicates that setting of the zoom ratio exceeding the predetermined zoom ratio is not available, until the condition ceases to be satisfied, when the condition is satisfied.

14. The method of claim 13, wherein the image processing apparatus is prohibited from performing copying, when the condition is satisfied.

15. The method of claim 13, wherein template registration is prohibited, when the condition is satisfied.

16. The method of claim 12, further comprising:
setting a document mode corresponding to a kind of original document to be read,
wherein in the signal processing of generating the image, the monochrome signal converted in the converting of the color signal is processed to generate the image when a document mode is set to a color document mode to read a color document, and the monochrome signal output in the reading of the original document is processed to generate the image when the document mode is set to a mode other than the color document mode.

17. The method of claim 12, further comprising:
inputting information regarding a page of an original document into which a cover sheet or a sheet is inserted,
wherein in the signal converting, a color signal read from the original document of the page input in the information inputting is converted into a monochrome signal based on the conversion characteristic in which the increase rate of the density of the monochrome signal after conversion is lower than the increase rate of the density of the color signal before conversion, and
wherein in the signal processing, the monochrome signal converted in the signal converting is processed to generate an image.

18. The method of claim 17, wherein in the signal processing, a monochrome signal read from an original document of a page other than the page input in the information inputting is processed to generate an image.

19. The method of claim 12, further comprising:
inputting information regarding a page of an original document into which a cover sheet or a sheet is inserted; and
determining whether an original document is a color document based on a color signal read from the original document of the page input in the information inputting,
wherein in the signal converting, when it is determined that the original document is the color document, the color signal is converted into a monochrome signal based on the conversion characteristic in which the increase rate of the density of the monochrome signal after conversion is lower than the increase rate of the density of the color signal before conversion, and
wherein in the signal processing, the monochrome signal converted in the signal converting is processed to generate an image.

20. The method of claim 19, wherein the image processing apparatus reads the original document using a 4-line CCD sensor.
